(19) United States
(12) Patent Application Publication
(10) Pub. No.: US 2026/0138158 A1
(43) Pub. Date: May 21, 2026

(54) Grill Cleaner Using Disposable Paper Towels

(71) Applicant: Yuyong Zhao, BUFFALO GROVE, IL (US)

(72) Inventor: Yuyong Zhao, BUFFALO GROVE, IL (US)

(21) Appl. No.: 18/954,811

(22) Filed: Nov. 21, 2024

(51) Int. Cl. B08B 1/14

(52) U.S. Cl. CPC B08B 1/14

(57) ABSTRACT

The present invention pertains to a grill cleaning device that uses disposable paper towels as cleaning refills. By using disposable paper towels, it provides a safe and efficient way to clean the grill without the need to constantly wash the cleaner itself. It also eliminates the health hazard associated with the metal brushes.

### PRIOR ART

Due to the typical high heat of outdoor grill cooking, grease and burnt food residue are very common. Cleaning is often difficult. A popular cleaning product is metal brush. Metal brush usually only cleans large pieces of food residues but can't remove the grease. And metal wires broken off from the brush pose health hazard. Another popular product is cleaning pads with a handle. Although cleaning pads don't have the health hazard as a metal brush, they share a serious drawback: grease accumulates on the brush and cleaning pads from the first use. And grease from grilling is usually very stubborn and hard to clean. A need exists for a more efficient and safe device to clean the grill.

### BACKGROUND OF THE INVENTION

The present invention pertains to the arts of a grill cleaner that is safe and easy to use. It uses a common household product, paper towel, as the disposable cleaning refill.

### SUMMARY OF THE INVENTION

The present invention includes a cleaning paper towel compartment with narrowed opening at the bottom, and a movable cover at the top that is pressed down on the paper towel during the cleaning process. For best result, the paper towel is fully wetted and the grill is heated before cleaning so the combination of heat and water can easily break down grease and food residue.

### BRIEF DESCRIPTION OF DRAWINGS

FIG. 1 is a perspective view of the cleaning device.

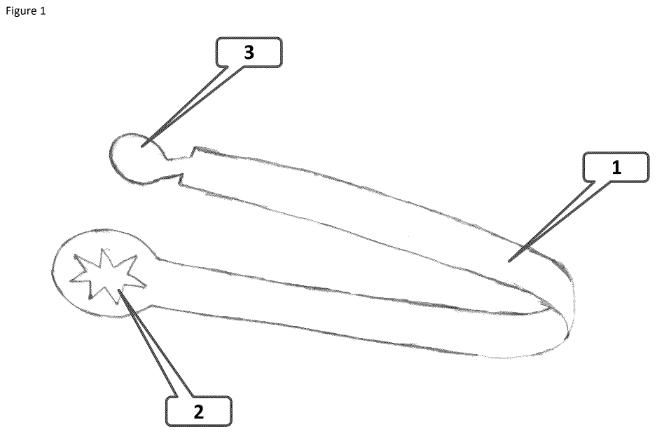

### DETAILED DESCRIPTION OF THE INVENTION

Referring to the drawing 1, (1) is the body of the cleaning device. The device is elastic so that the two prongs are separated for paper towel release when not pressed. (2) is the paper towel compartment with serrated opening at the bottom. The compartment wall is curved, wider at the top and narrower at the bottom to hold paper towels in place. (3) is the cover of the paper towel compartment. It is curved with similar shape of the compartment, so it keeps pressing on the paper towel when pressed during cleaning.

While the forms of apparatus disclosed herein constitute preferred embodiments of the present invention, those knowledgeable in the art understand that the invention is not limited to these precise forms of apparatus, and that changes may be made therein without departing from the scope of the invention as defined by the appended claims.

1. A grill cleaning device that uses paper towel as cleaning refills, consisting of a paper towel compartment with opening at the bottom, and a movable cover at the top to press on the paper towel during cleaning.
